(19) United States
(12) Patent Application Publication
(10) Pub. No.: US 2014/0079354 A1
(43) Pub. Date: Mar. 20, 2014

(54) METHOD FOR PRODUCING OPTICAL CONNECTOR AND OPTICAL CONNECTOR

(71) Applicant: FUJITSU LIMITED, Kawasaki-shi (JP)

(72) Inventors: Tsuyoshi Aoki, Machida (JP); Shigenori Aoki, Atsugi (JP); Hidenobu Muranaka, Atsugi (JP)

(73) Assignee: FUJITSU LIMITED, Kawasaki-shi (JP)

(21) Appl. No.: 13/950,653

(22) Filed: Jul. 25, 2013

(30) Foreign Application Priority Data
Sep. 18, 2012 (JP) 2012-204864

(51) Int. Cl. G02B 6/38

(52) U.S. Cl. CPC G02B 6/38
USPC 385/72; 29/428

(57) ABSTRACT

A method for producing an optical connector includes making only the core jut spherically from an end facet of an optical fiber by arc discharge, the optical fiber having a difference in index of refraction between a core and a clad at 1% to 3% by adding dopant that increases an index of refraction of the core and lowers a melting point of the core, and mounting the optical fiber processed by the arc discharge in a ferrule.

### CROSS-REFERENCE TO RELATED APPLICATION

This application is based upon and claims the benefit of priority of the prior Japanese Patent Application No. 2012-204864, filed on Sep. 18, 2012, the entire contents of which are incorporated herein by reference.

### FIELD

The embodiment discussed herein is related to methods for producing an optical connector and optical connectors.

### BACKGROUND

High-performance computers (HPCs), servers, and so forth demand an interconnection technology by which wideband and low-power consumption communication between LSIs is performed. As a technique to implement such an interconnection technology, optical interconnection is drawing an attention.

In the HPCs, the servers, and so forth, LSIs that perform a computation are disposed on individual boards, and a plurality of boards are connected to a backplane. In the optical interconnection, an electric signal generated by the LSI on the board is converted into an optical signal by a photoelectric conversion element, and the optical signal is transmitted to another board. On the other board, the optical signal is reconverted into an electric signal, and the electric signal is received by the LSI. In this case, an optical transmission line is placed on the backplane or inside the backplane, and, also on each of the individual boards, an optical transmission line is placed from the photoelectric conversion element to the board edge. The boards and the backplane are coupled to one another via optical connectors.

Since the backplane is large in size, an optical fiber is considered as an effective way to perform transmission with low losses at the moment. Since the individual boards are placed in such a way as to be detachable from the backplane for the purpose of maintenance and in accordance with a system configuration, an optical fiber-based optical connector is disposed at the board edge and on the backplane.

However, to use an optical connector used in optical communication and so forth in optical interconnection in the device, high-precision polishing is desired. Optical connectors for optical communication are designed to make physical contact (PC) connection with each other to connect the optical fibers to each other with low losses and low reflection. Therefore, as depicted in FIGS. 1A and 1B, an end face 120a of an optical fiber 120 is processed to have a convex shape in a state in which the tip of the optical fiber 120 (a core 121 and a clad 122) is made to jut slightly from a mating face 10a of a ferrule 10. To achieve such a shape, high-precision polishing is desired. In interconnection of the HPCs, the servers, and so forth that uses a great number of optical connectors, an optical connector that demands high-precision polishing is not suitable.

As a technique of performing PC connection by using unpolished optical fibers, a method by which, after an entire end face of an optical fiber jutting from a ferrule is processed to have a spherical shape by using arc discharge, the optical fiber is positioned has been known (see, for example, Japanese Laid-open Patent Publication No. 2000-019342). With this method, the outside diameter near the fiber tip is increased by slight variations in discharge condition, which makes it difficult to mount the fiber on the ferrule and reduces yields. As another method, a method by which a core is made to jut by removing a clad by etching at an end of a waveguide formed on a substrate and making an end face of the core spherical by reflowing or laser irradiation has been known (see, for example, Japanese Laid-open Patent Publication No. 9-304664).

### SUMMARY

According to an aspect of the embodiment, a method for producing an optical connector includes making only the core jut spherically from an end facet of an optical fiber by arc discharge, the optical fiber having a difference in index of refraction between a core and a clad at 1% to 3% by adding dopant that increases an index of refraction of the core and lowers a melting point of the core, and mounting the optical fiber processed by the arc discharge in a ferrule.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are diagrams for explaining end-face polishing of an optical fiber for PC connection;

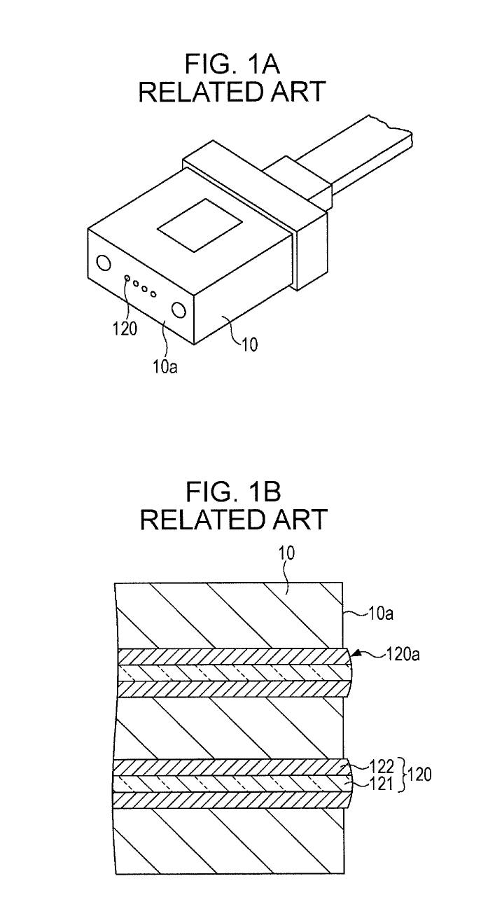

FIG. 2 is a diagram for explaining processing of the tip of an optical fiber of an embodiment;

FIGS. 3A to 3C are production process diagrams of an optical connector of the embodiment;

FIG. 4 is a graph of the relationship between the difference in index of refraction and propagation loss;

FIGS. 5A to 5C are optical micrographs and a schematic diagram thereof obtained when arc discharge processing was performed on the tip of the optical fiber;

FIG. 6 is a schematic configuration diagram of the optical connector in which the optical fiber of the embodiment is mounted;

FIGS. 7A and 7B are diagrams of fiber-fiber connection using the optical connector of the embodiment;

FIGS. 8A and 8B are diagrams of fiber-polymer waveguide connection using the optical connector of the embodiment;

FIGS. 9A and 9B are diagrams of the mating state of the optical connectors of FIGS. 5A to 5C; and

FIG. 10 is a diagram of an example of optical interconnection to which the optical connector of the embodiment is applied.

### DESCRIPTION OF EMBODIMENT

Hereinafter, an embodiment will be described with reference to the drawings. The embodiment provides a method for producing an optical connector having an optical fiber that is inserted into a ferrule easily and is suitable for PC connection and an optical connector that is produced by this method.

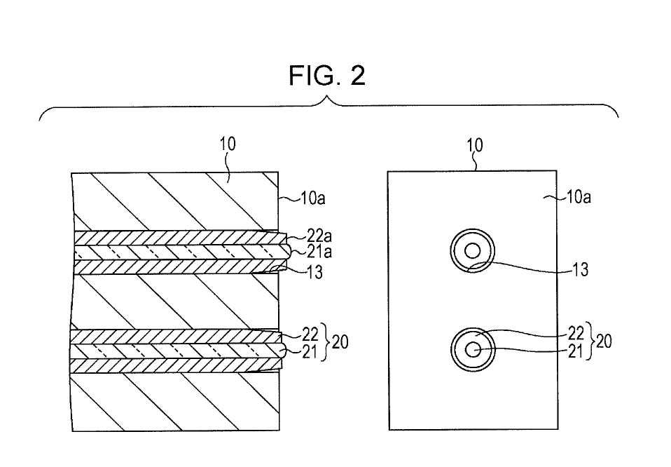

FIG. 2 is a schematic diagram of an optical fiber 20 held by a ferrule 10. The optical fiber 20 is a silica-based fiber. Dopant is added to a core 21 in such a way that the index of refraction of the core 21 becomes higher than the index of refraction of a clad 22 and the melting point of the core 21 becomes lower than the melting point of the clad 22. The difference in index of refraction between the core 21 and the clad 22 is 1% to 3%.

The optical fiber 20 is inserted in a fiber guide hole 13 formed in the ferrule 10. The core 21 of the optical fiber 20 has a tip jutting from an end face 22a of the clad 22 as a spherical projection 21a. The outer periphery of the tip of the clad 22 tapers off (has a tapered shape), and the outside diameter at the end face 22a of the clad 22 is smaller than the outside diameter of the other portion. The fiber guide hole 13 is generally injection molded with a fiber diameter accuracy of ±1 μm, but the tapered tip of the clad 22 makes it easy to insert the optical fiber 20 into the fiber guide hole 13.

In a state in which the ferrule 10 does not fit over a ferrule of another connector, the end face 22a of the clad 22 juts from the mating face 10a of the ferrule 10. Therefore, the spherical projection 21a of the core 21 also juts from the mating face 10a of the ferrule 10. When the ferrule 10 fits over a ferrule of another connector, the optical fiber 20 is capable of moving backward in the fiber guide hole 13. At this time, PC connection with a core of another optical fiber is established in a state in which the spherical projection 21a of the core 21 slightly juts from the mating face 10a of the ferrule 10.

Since the spherical projection 21a of the core 21 juts from the end face 22a of the tapered clad 22, even when another connector is a polymer waveguide optical connector, it is possible to protect a polymer waveguide core from damage at a cut surface of the optical fiber 20.

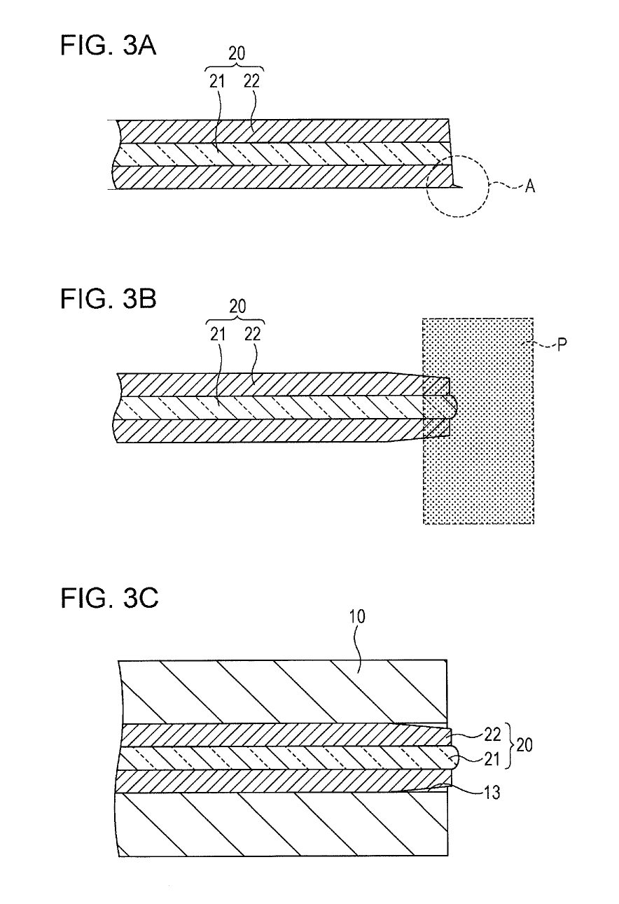

FIGS. 3A to 3C are diagrams of a production process of an optical connector using the optical fiber 20 of FIG. 2. First, as depicted in FIG. 3A, the silica-based optical fiber 20 with a core to which dopant is added in such a way that the difference in index of refraction between the core 21 and the clad 22 becomes 1% to 3% is prepared. The type of dopant is a material that increases the index of refraction of the core and lowers the melting temperature of the core. As the dopant that increases the index of refraction of the core and lowers the melting point of the core in accordance with the concentration of the added dopant, in addition to GeO₂ and P₂O₅, Al₂O₃ and oxides and chlorides having elements such as Er, Nd, Yb, La, Tm, and Pr which are rare-earth elements may be used. The dopant may include at least one of GeO₂, P₂O₅, a rare-earth oxide, and a rare-earth chloride. It is preferable that the difference in index of refraction Δ between the core 21 and the clad 22 be in the range of 1% to 3%. As an example, when quartz glass whose index of refraction for light with wavelength of 1 μm is 1.45 is used as the clad, silica glass doped with GeO₂ in such a way that the difference in index of refraction Δ becomes 1% to 3% is used as core glass. When the difference in index of refraction Δ is less than 1%, it is difficult to melt only the core 21 before other parts to make the core 21 jut from the end face of the clad 22. Moreover, it is impossible to reduce bend loss adequately. When the difference in index of refraction Δ exceeds 3%, it becomes impossible to ensure the clad diameter for the optimization of stress for the bend radius. Moreover, propagation loss is increased.

In general, by increasing the difference in index of refraction between the core and the clad, it is possible to reduce the bend radius. However, to achieve a small bend radius, it is also important to ensure long-term reliability for stress. When a clad with an outside diameter of 125 μm is used, the bend radius is 15 mmR when the difference in index of refraction Δ between the core and the clad is 1%. When the difference in index of refraction Δ is 2%, the bend radius may be set at 5 mmR when a clad with an outside diameter of 80 μm is used. When the difference in index of refraction Δ exceeds 3%, the bend radius may be a few mmR, but the clad outside diameter becomes 60 μm or less. The clad outside diameter has to be greater than or equal to the core diameter. When the core diameter is 50 μm, a clad with an outside diameter of 60 μm or less does not fulfill a function as a clad. Therefore, it is desirable that the difference in index of refraction Δ be 3% or less.

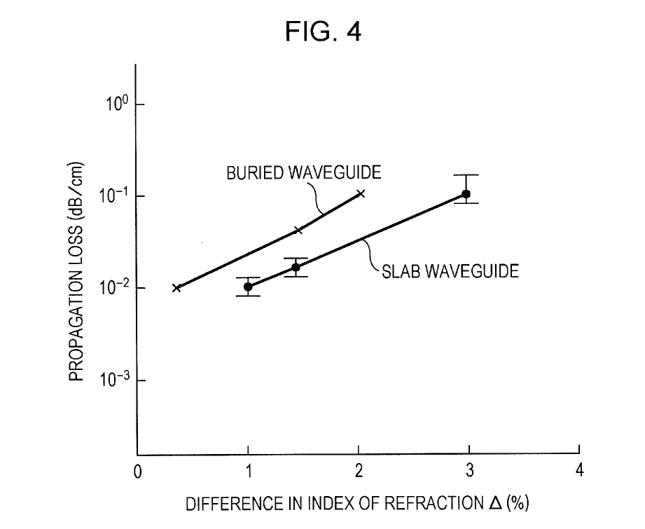

The upper limit of the difference in index of refraction is also based on propagation loss. When the difference in index of refraction between the core and the clad becomes 3%, propagation loss is increased by about ten times as compared to a case in which the difference in index of refraction is 1%. This is also supported by the dependence of propagation loss on the difference in index of refraction when a glass film with a high index of refraction is formed on a quartz substrate and a slab waveguide and a buried waveguide are formed as depicted in FIG. 4.

As described above, the range of the difference in index of refraction Δ between the core and the clad is set at 1% to 3% because otherwise it is impossible to ensure the clad diameter for the optimization of stress for the bend radius and propagation loss reaches a limit.

Back in FIG. 3A, the optical fiber 20 with the core 21 to which the dopant is added in such a way that the melting point of the core 21 is lowered and the difference in index of refraction between the core 21 and the clad 22 becomes 1% to 3% is cut by a laser cutter. For convenience of illustration, only one optical fiber 20 is depicted, but, usually, a plurality of optical fibers 20 are collectively cut. For example, a tape coating of an optical fiber ribbon is stripped off, and the exposed optical fibers are cut into a desired length. By using laser processing, a difference of angle is small and it is possible to reduce length variation to 5 μm or less, but, at the time of cutting, an inclination of a cut surface or a burr (a ledge that develops at an end when processing is performed) may develop (see a portion of circle A). However, by arc discharge processing in a subsequent process, it is possible to reduce the influence of a fiber cut surface on another connector.

In FIG. 3B, the cut optical fiber 20 is set in a fusion splicer or the like, and tip processing by arc discharge is performed. As an example, a fusion splicer FSM-20PM II Type N manufactured by Fujikura Ltd. is used. Arc discharge is performed by setting a discharge current at 10.3 to 13 mA and a processing time at 300 to 1000 msec in accordance with the difference in index of refraction between the core and the clad, a doping amount, the core diameter, and so forth. The core 21 is preferentially melted by thermal plasma (P) generated by arc discharge, and the clad 22 is slightly melted or softened. The end of the melted core 21 changes into a spherical shape by surface tension, and the outside diameter of the clad 22 tapers off. Since the melting point of the core is lower than the melting point of the clad, it is possible to perform processing, by small arc power, in such a way that only the core 21 has a shape that juts from the end facet of the optical fiber 20 in the form of a lens. The clad 22 is drawn inward by the volume of a spherical jutting portion of the core 21 and has a tapered shape depicted in FIG. 3B.

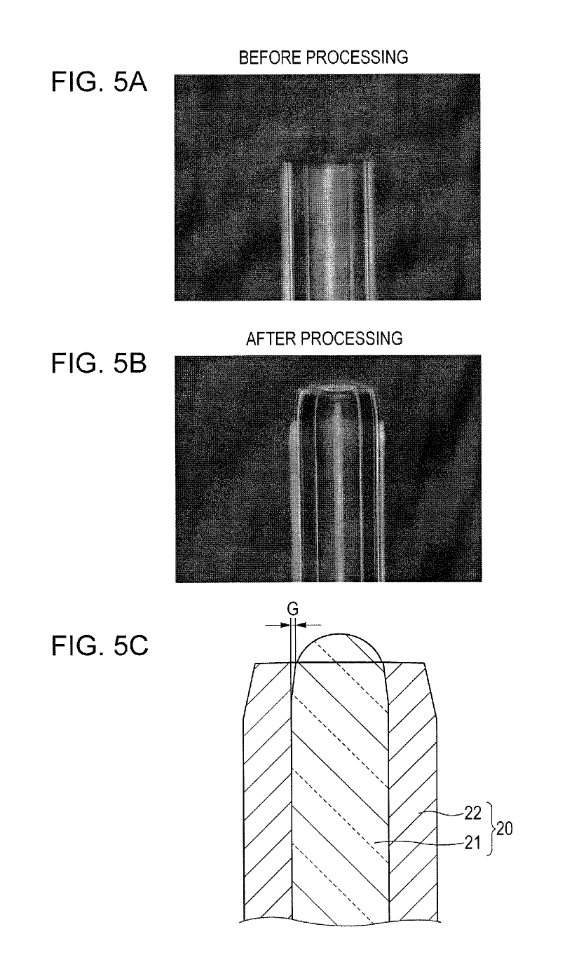

FIGS. 5A to 5C are optical micrographs and a schematic diagram thereof obtained when arc discharge was performed on the tip of the quartz fiber 20 doped with Ge, the quartz fiber 20 with a core diameter of 50 μm, a clad outside diameter of 80 μm, and a difference in index of refraction Δ of 2%, on the conditions that a discharge current is 11 mA and a processing time is 500 msec. The length of a jutting portion of the tip section of the core 21 thus processed is 0.4 μm, and the core outside diameter is compressed at the tip of the core by about 1 μm. The outside diameter of the core is compressed by the volume of a core tip section spherically jutting by surface tension (see character G of FIG. 5C), and the outside diameter of the clad also tapers off by the compression of the core outside diameter. As is clear from FIGS. 5A to 5C, it is possible to achieve an accurate tapered shape of the clad side face and a spherical shape of the core jutting from the clad tip.

Back in FIG. 3C, the optical fiber 20 subjected to tip processing is inserted into the fiber guide hole 13 of the ferrule 10, and the root of the optical fiber 20 is fixed by an adhesive while being positioned. In general, the difficulty of a process of inserting a fiber into a ferrule poses a production problem. In the optical fiber 20 of the embodiment, however, since the tip of the clad 22 has a tapered shape, it is easy to insert the optical fiber 20 into the fiber guide hole 13. Incidentally, when a coating is applied to the optical fiber 20 subjected to arc discharge processing, a hole for spraying may be provided in the ferrule 10, and, after the optical fiber 20 is fixed in the ferrule by an adhesive, polyimide or the like may be sprayed thereon with a spray. By applying a coating to the optical fiber 20, it is possible to enhance the resistance to the application of stress and bending of the fiber and thereby increase the reliability of a product.

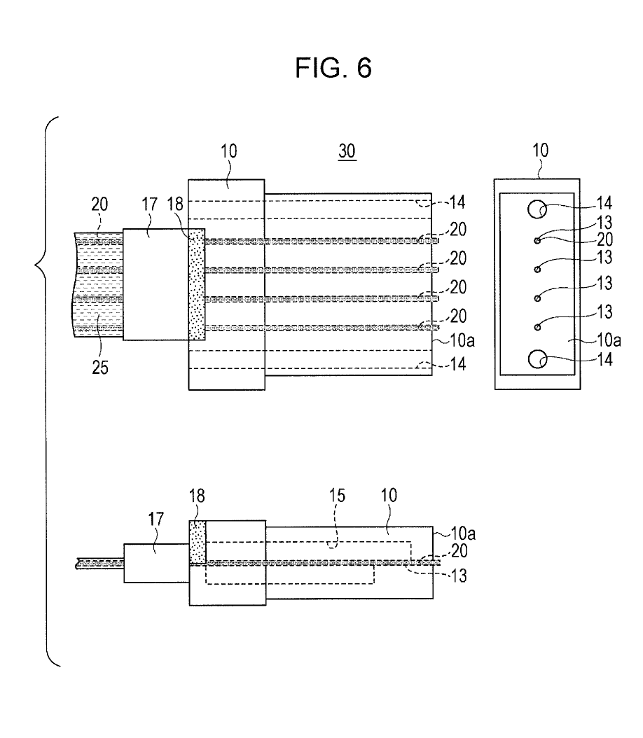

FIG. 6 is a schematic configuration diagram of an optical connector 30 in which the optical fiber 20 processed by the method of FIGS. 3A to 3C is mounted. The optical connector 30 includes the optical fiber 20 and the ferrule 10 that holds the optical fiber 20. In an example of FIG. 6, the optical connector 30 is a multifiber connector, and a plurality of optical fibers 20 are bundled together by a tape coating 25. The optical fibers 20 bundled together by the tape coating 25 are placed in a boot 17 and mounted in the ferrule 10. As depicted in FIG. 3C, each optical fiber 20 has the core 21 spherically jutting from the end facet of the clad 22 having a tapered shape.

Inside the ferrule 10, a space 15, the fiber guide hole 13 communicating with the space 15, and a guide pin hole 14 are provided. The optical fiber 20 inserted into the fiber guide hole 13 through the space 15 is held in a state in which the optical fiber 20 juts from the mating face of the ferrule 10. The root side of the optical fiber 20 extending from the tape coating 25 is fixed by an adhesive 18 at a rear end of the ferrule 10.

The optical fibers 20 have length variation produced at the time of laser cutting. Therefore, the lengths of the portions of the optical fibers 20 jutting from the mating face 10a of the ferrule 10 also vary. The length variation is cancelled inside the space 15 when PC connection is established between the optical fibers 20 and another connector.

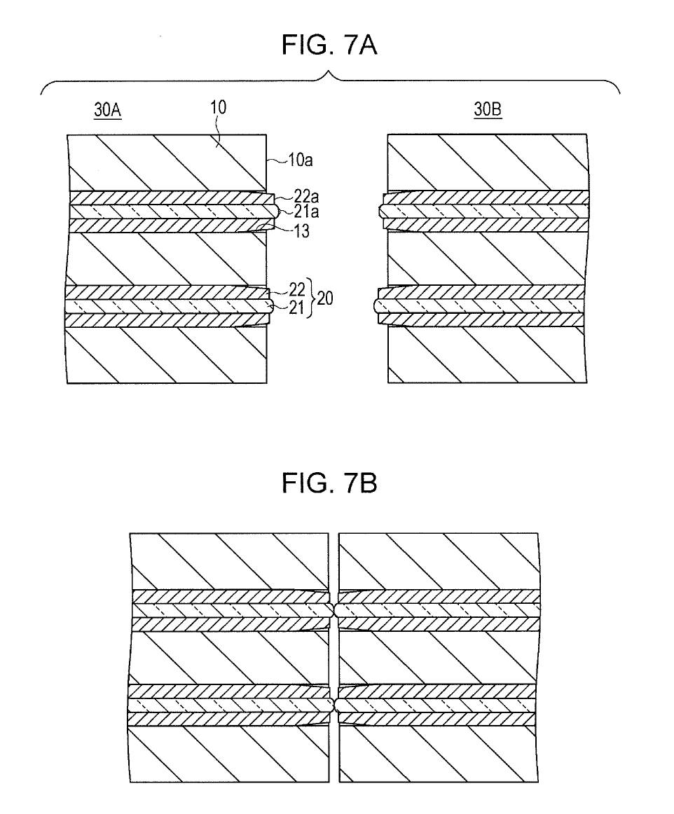

FIGS. 7A and 7B are diagrams of PC connection between the optical fibers when the connectors are mated with each other. In FIG. 7A, an optical connector 30A and an optical connector 30B are placed in such a way as to face each other. Each optical fiber 20 has the end face 22a of the clad 22, the end face 22a from which the spherical projection 21a of the core 21 juts. When a GI50 multimode fiber (with a core diameter of 50 μm) with a difference in index of refraction of 2% is used, the length of a portion of the fiber core 21, the portion jutting from the end face 22a of the clad 22, is 0.4 μm.

As depicted in FIG. 7B, the corresponding optical fibers 20 are connected to each other by mating the optical connectors 30A and 30B with each other. By setting the pressing force per optical fiber at 2.0 N, it is possible to establish PC connection between quartz fibers by slightly elastically-deforming the projection 21a of the core 21. PC connection is advantageous because the PC connection produces little reflection loss. When a vertical-cavity surface emitting laser (VCSEL) is used as a light source in optical interconnection, the mode is often in a low-order mode. In this case, it is possible to establish PC connection without processing the projection 21a of the core 21 of the multimode fiber into a perfect sphere. By increasing the pressing force per optical fiber, it is possible to make the radius of curvature of the elastically-deformable core 21 smaller. In other words, even when the projection 21a of the core 21 of the optical fiber 20 has a steeper jutting shape, by increasing the pressing force, it is possible to establish PC connection between the optical fibers 20.

As the type of the optical fiber 20, in addition to a multimode fiber, the optical fiber 20 may be a single-mode fiber with a core diameter of about 10 μm. When the single-mode fiber is adopted, a jutting spherical portion of the fiber core 21 is longer than a jutting spherical portion of the fiber core 21 of the multimode fiber. However, since the core diameter is small, it is possible to reduce the pressing force that is applied to one fiber to a pressing force smaller than 2.0 N. When the single-mode core is adopted, the outside diameter is also compressed at the fiber tip by about 1 μm.

Processing the tip of the single-mode fiber into the shape of the embodiment is particularly advantageous in establishing connection with a silicon waveguide. When a core of an optical fiber is connected, directly or via a spot-size converter, to a core end face of a transmission line formed on a substrate by silicon photonics, it is possible to establish PC connection reliably and reduce transmission loss.

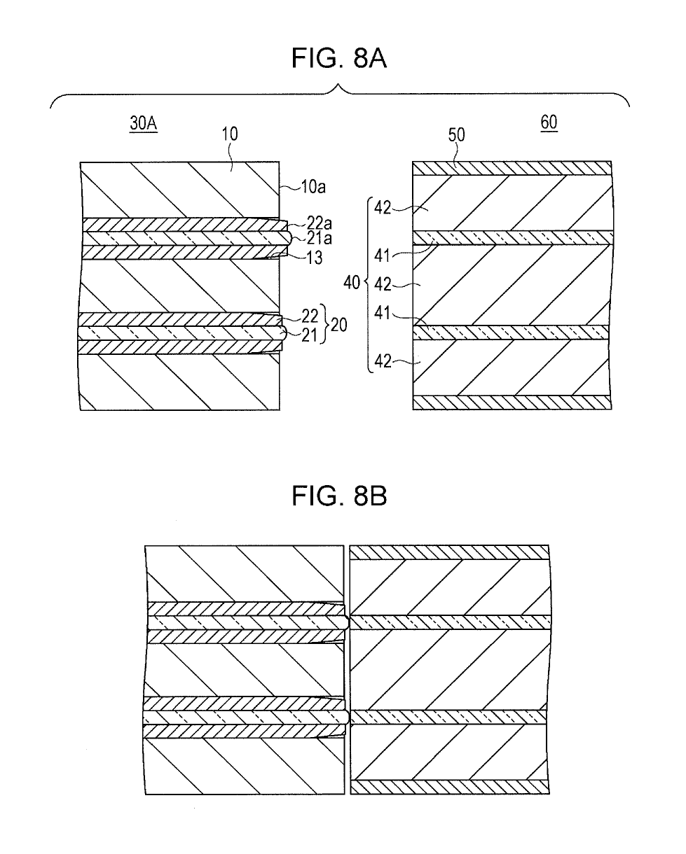

FIGS. 8A and 8B are schematic diagrams when the optical connector 30A of the embodiment is connected to a polymer waveguide connector 60. In the connector 60, a flexible polymer waveguide 40 is held in a ferrule 50. An example of a core 41 of the polymer waveguide 40 is a multimode core measuring 50 μm per side, and the cores 41 are spaced at the same intervals as the optical fibers 20, for example, at the intervals of 250 μm. The ferrule 50 of the connector 60 is a PMT ferrule having the same size as an MT ferrule and being compatible with the MT ferrule, and it is possible to perform accurate positioning of the ferrule 50 for the optical fiber 20 of the optical connector 30A by using a guide pin or the like.

The optical connector 30A and the polymer waveguide connector 60 are placed in such a way as to face each other, and PC connection is established between the fiber core 21 of the optical connector 30A and the waveguide core 41 of the polymer waveguide connector 60. The length of a jutting portion of the core 21 of the optical fiber 20 is 2.0 μm, and the pressing force of the core 21 is 2.0 N. Since the coefficient of elasticity of the polymer waveguide 40 is incomparably lower than the coefficient of elasticity of quartz, the projection 21a of the core 21 of the quartz-based optical fiber 20 achieves PC connection by elastically-deforming the end face of the waveguide core 41.

The length of a jutting portion of the core 21 of the optical fiber 20 and the pressing force of the core 21 are not limited to those of this example, but the length of a jutting portion of the core 21 of the optical fiber 20 and the pressing force of the core 21 are set in such a way that the yield stress of a material forming the polymer waveguide 40 is not exceeded by the deformation at the time of mating. In an existing unpolished fiber, inclination or a burr that develops in a fiber end face as a result of being cut by a cutter often damages the polymer waveguide core, and connection loss is increased as the optical connector is repeatedly inserted and disconnected. On the other hand, as in the optical connector of the embodiment, by processing the tip of the fiber core 21 into a spherical shape jutting from the clad 22, it is possible to perform insertion and disconnection of the connector without damaging the waveguide core of another connector.

As another optical connector to which the optical connector is connected, in place of the optical connector 30B using a quartz fiber and the polymer waveguide connector 60, a connector for a plastic optical fiber (POF) or a connector for a hard plastic clad fiber (H-PCF) may be used.

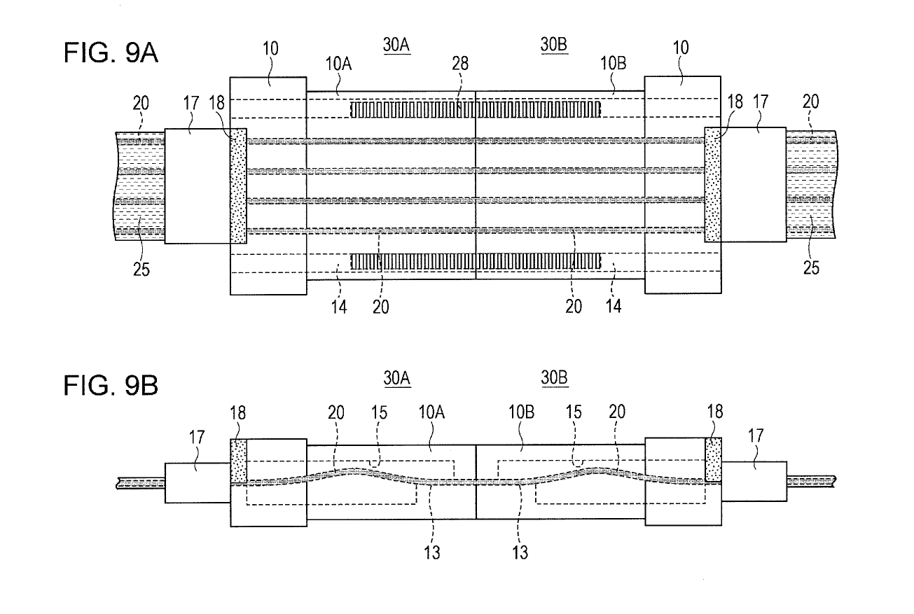

FIGS. 9A and 9B are diagrams of the mating state of the optical connector 30A and the optical connector 30B. FIG. 9A is a top view, and FIG. 9B is a side view. After the optical connectors 30A and 30B are positioned by guide pins 28, the optical connectors 30A and 30B press the ferrules 10A and 10B against the optical connectors 30B and 30A, respectively, by springs or the like. The jutting optical fibers 20 establish PC connection at the projections 21a of the cores 21 while being pushed toward the inside (see FIGS. 7A and 7B). When the lengths of the optical fibers 20 vary greatly, if a load is collectively imposed on the optical fibers 20 to push the optical fibers 20 into the ferrules 10A and 10B by springs or the like, a uniform load is not imposed on the optical fibers 20. In this case, there is a possibility that PC connection is not established in some channels.

To solve this problem, in the embodiment, the spaces 15 are provided in the ferrules 10A and 10B, the roots of the optical fibers 20 are fixed by the adhesive 18, and, as depicted in FIG. 6, the optical fibers 20 are held in a state in which the tips of the optical fibers 20 are made to slightly jut.

When the optical connectors 30A and 30B are connected to each other, the optical fibers 20 make contact with the corresponding optical fibers 20 in decreasing order of length of a jutting portion of the optical fiber 20. The optical fibers 20 are movable in the fiber guide holes 13 of the ferrules 10A and 10B, and the excess portions slightly buckle in the internal spaces 15. As a result of the optical fibers 20 buckling in the spaces 15, it is possible to impose independent buckling loads on the optical fibers 20 in an axial direction.

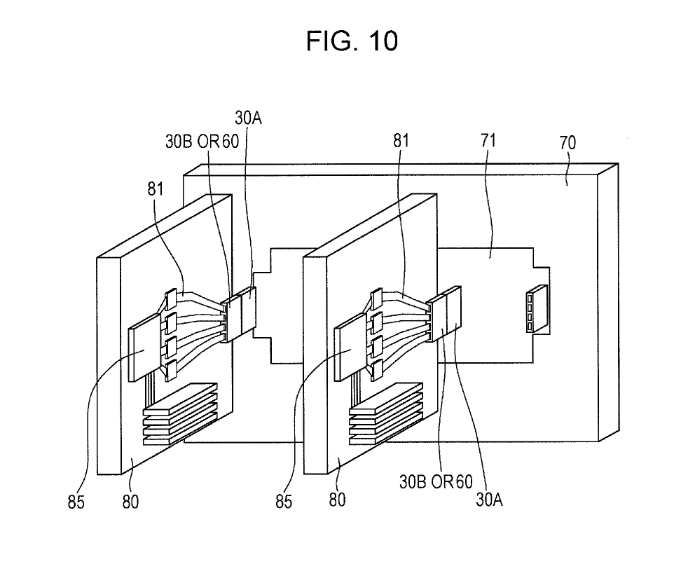

FIG. 10 is an example of optical interconnection to which the optical connector 30 of the embodiment is applied. A board 80 on which an LSI 85 is mounted is connected to a backplane 70 via the optical connectors 30A and 30B or 60. An optical transmission line 71 on the backplane 70 is, for example, a transmission line using an optical fiber.

The optical connector 30 of the embodiment is applicable to a connector located on the backplane 70 and a connector located on the board 80. When the fiber-based optical connectors 30A and 30B are adopted as these connectors, as depicted in FIGS. 7A and 7B, PC connection between the optical fibers 20 is established. When the polymer waveguide connector 60 is adopted as the connector on the board 80, a connection mode depicted in FIGS. 8A and 8B is obtained. As a transmission line 81 on the board 80, a flexible waveguide is often adopted from the viewpoint of ease of routing and resistance to bending. The optical connector 30 of the embodiment is useful also in fiber-polymer waveguide connection.

As described above, in the method of the embodiment, the index of refraction of the core is made higher than the index of refraction of the clad and the melting point of the core is made lower than the melting point of the clad by controlling the doping amount of dopant with which the quartz fiber core is doped. The difference in index of refraction between the core and the clad is 1% to 3%. By processing such an optical fiber with arc power that is smaller than the arc power of the existing arc discharge method, it is possible to make only the core jut from the end face of the optical fiber by preferentially melting the core portion. This configuration makes it easy to perform PC connection with other transmission lines (such as an optical fiber, a polymer waveguide, a POF, and an H-PCF).

Even when insertion into and disconnection from the polymer waveguide or the plastic optical fiber (POF) is repeatedly performed, it is possible to reduce damage to the polymer waveguide or the POF. By providing the fiber tip with a tapered shape, it is easy to perform a process of inserting a fiber into a ferrule, making it possible to achieve cost reduction. When a multifiber connector is adopted, it is possible to absorb length variation between the optical fibers by buckling of the optical fibers in the spaces in the ferrules. It is easy to perform the arc discharge processing as compared to precision processing performed by polishing and it is possible to reduce costs. By combining laser processing and arc discharge, it is possible to form a tapered shape of the clad tip and a spherical projection of a core, the projection jutting from the clad end face. Therefore, high-precision PC connection is implemented.

The structure described in the embodiment is a mere example, and it is possible to implement any quartz fiber even when the clad outside diameter and the core diameter thereof are different from the clad outside diameter and the core diameter of the embodiment. As the optical connector, in addition to a multifiber connector, a single-core connector such as common SC and FC may be used.

It is possible to apply the optical fiber of the embodiment not only to a mating connector but also to a mechanical splice or the like and use the optical fiber of the embodiment when permanent connection to a waveguide device is performed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method for producing an optical connector, comprising:
making only a core jut spherically from an end facet of an optical fiber by arc discharge, the optical fiber having a difference in index of refraction between a core and a clad at 1% to 3% by adding dopant that increases an index of refraction of the core and lowers a melting point of the core; and
mounting the optical fiber processed by the arc discharge in a ferrule.

2. The method for producing an optical connector according to claim 1, wherein
an outer periphery of a clad tip portion is processed into a tapered shape by the arc discharge.

3. The method for producing an optical connector according to claim 1, further comprising:
cutting the optical fiber to which the dopant is added into a predetermined length prior to the arc discharge.

4. The method for producing an optical connector according to claim 1, wherein
the dopant includes at least one of GeO₂, P₂O₅, a rare-earth oxide, and a rare-earth chloride.

5. The method for producing an optical connector according to claim 1, wherein
the arc discharge is performed for 300 to 1000 msec by setting a discharge current at 103 to 13.0 mA.

6. The method for producing an optical connector according to claim 1, wherein
the mounting in the ferrule includes inserting the optical fiber processed by the arc discharge into a fiber guide hole formed in the ferrule.

7. An optical connector, comprising:
an optical fiber; and
a holding section that holds the optical fiber; wherein
a difference in index of refraction between a core and a clad of the optical fiber is 1% to 3%, and
the core spherically juts from an end face of the clad at a tip of the optical fiber.

8. The optical connector according to claim 7, wherein
the clad has a tapered outer periphery at the tip of the optical fiber.

9. The optical connector according to claim 7, wherein
to the core of the optical fiber, dopant that increases an index of refraction and lowers a melting point is added.

10. The optical connector according to claim 7, wherein
the tip of the optical fiber juts from the ferrule when the optical connector does not mate with another connector, and
the ferrule has a space inside and allows the optical fiber to buckle in the space when the optical connector mates with another connector.
